(19) United States
(12) Patent Application Publication
(10) Pub. No.: US 2004/0029538 A1
(43) Pub. Date: Feb. 12, 2004

(54) Method and apparatus for capacity changes in transceiver apparatus and base station with such a transceiver

(76) Inventors: Harri Holma, Helsinki (FI); Zhi-Chun Honkasalo, Kauniainen (FI); Matti Kiiski, Oulunsalo (FI); Kari Leppanen, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/312,444

(22) PCT Filed: Jun. 1, 2001
(86) PCT No.: PCT/EP01/06285

(30) Foreign Application Priority Data
Jun. 29, 2000 (GB) 0016008.5

(51) Int. Cl. H04B 1/04

(52) U.S. Cl. 455/121; 455/115.1

(57) ABSTRACT

The present invention relates to transceiver apparatus. The transceiver apparatus is adapted to transmit within the coverage area of one or more transmission beams. The beams are provided by means of at least one transmission branch. In the method the number of transmission branches of the transceiver is changed, whereafter the shape of at least one of the transmission beams is modified by means of digital beamforming.

### FIELD OF THE INVENTION

The present invention relates to transceiver apparatus, and in particular, but not exclusively, to capacity changes in transceiver apparatus.

### BACKGROUND OF THE INVENTION

Transceiver apparatus may be used e.g. in a base transceiver station (BTS) of a cellular telecommunications network. The base transceiver station may provide a mobile user, or more precisely, user equipment or terminal with circuit switched service and/or packet switched service via a wireless interface between the user and the base station. Examples of the different telecommunications systems for wireless communication include, without limiting to these, specifications such as GSM (Global System for Mobile communications) or various GSM based systems (such as GPRS: General Packet Radio Service), AMPS (American Mobile Phone System), DAMPS (Digital AMPS), third generation telecommunication systems such as the WCDMA (Wideband Code Division Multiple Access) or TD/CDMA in UMTS (Time Division/Code Division Multiple Access in Universal Mobile Telecommunications System) and IS-95 (Interim Standard No. 95) and so on.

In the initial network deployment stage the coverage that a base station is capable of providing is typically considered to be a more important aspect than the capacity that the base station may provide. However, if the amount of traffic increases in the cell served by the base station, the importance of capacity increases. Therefore it may be necessary to be able to increase the capacity of the base station. The skilled person knows that typically the coverage of a base transceiver station is limited by the uplink performance of the transceiver apparatus of the base station (i.e. transmissions towards the base station). A reason for this is that the transmission power of the mobile station is much lower than the transmission power of a macro cell base station. The uplink performance typically depends heavily on the number of receiver branches that are provided in the base station, a greater number of receiver branches resulting a better reception coverage.

The capacity of the base station is typically limited by the downlink performance (i.e. by the performance of the transmission elements that transmit towards mobile stations). This is believed to be the case especially in a third generation (3G) environment and with services that are based on asymmetrical downloading. An example of an asymmetric situation is browsing and downloading of WWW (World Wide Web) pages in the Internet, wherein it may be assumed that in most occasions downloading of data into a mobile station takes more time (and bandwidth) than transmission of data from the mobile station.

In a so called smart antenna system the downlink performance depends on the number of transmission branches. In an analogue fixed beam implementation a transmission branch produces a transmission beam covering a geographical coverage area on which the transmitter may successfully transmit to a mobile station within the beam coverage area. In a digital beam forming implementation each transmission branch feeds a single antenna element or antenna element polarisation port. In both the analogue and digital implementations a greater number of transmission branches provides a better capacity, as the beams can be made narrower and may thus the area served by a beam can be made smaller.

A transmission branch typically comprises an antenna element, a power amplifier and digital and/or analogue circuitry required to generate the signal to be transmitted by the antenna element. Each transmission branch is typically provided with a power amplifier of its own. It is also possible to have more than one power amplifier per a transmission branch. This may be the case e.g. when substantially high transmission powers are required. If more that one power amplifier is used for a branch, then the amplifiers are typically summed into one antenna element and can be seen as one logical power amplifier.

The power amplifiers can be substantially expensive and may be one of the major cost factors of a base station. The cost factor may even be more critical in the 3G systems since they in general require use of more linear power amplifiers (and thus more expensive) than what is required e.g. by the GSM system or other more conventional cellular systems. Thus the provision of an added number of transmission branches may increase substantially the overall costs of a base station. In other words, the more capacity required, the more expensive the base station is because the power amplifiers are a substantially expensive part of the base station.

FIG. 1 shows a block diagram of a transceiver with four transmission branches and four receiving branches. If the number of the receiving branches and the transmission branches is the same, this should provide in most occasions a sufficient capacity. In addition, if equal number of receiving and transmission branches is provided, the capacity may be increased at the same time when the coverage is improved. However, the provision of equal number of branches may lead to a substantial overcapacity, at least in the initial phase of a new network. If there is too much capacity, the initial base station investment may be too expensive. The high initial cost may deter the investment altogether and/or delay the expansion of the new network to potential new areas. In addition, the inventors have found that the present base stations may not allow flexible enough facilities to enable a upgrade of the capacity thereof. The inventors have also found that there may be occasions where it might be useful to be able to reduce the capacity of the transceiver apparatus. It might also be useful to be able to replace an element of the base station by a cheaper element and/or to be able to remove an element from the base station.

### SUMMARY OF THE INVENTION

It is an aim of the embodiments of the present invention to address one or several of the above problems.

According to one aspect of the present invention, there is provided a method in transceiver apparatus, the transceiver transmitting within the coverage area of one or more transmission beams provided by means of at least one transmission branch, the method comprising: changing the number of transmission branches of the transceiver; and modifying the shape of at least one transmission beam by means of digital beamforming.

In more specific embodiments, the number and/or angular width of transmission beams may be changed. Said at least one beam may be shaped by means of phasing the baseband signals of the transmission branches. The phasing may comprise multiplying complex digital samples in each transmission branch with a complex weight factor. The digital beam forming may be adaptive.

The receiver function of the transceiver may be provided with receiver branches, the initial number of the receiver branches being greater than the initial number of the transmission branches. The number of transmission branches may be increased to equal the number of receiver branches.

At least one of the transmission beams may be shaped to be narrower than a transmission beam that was provided by the transceiver apparatus before the change. The capacity of the transceiver apparatus may be increased by increasing the number of the transmission amplifiers for increasing the number of transmission branches and shaping at least one of the transmission beams produced by the increased number of the transmission branches so that at least one transmission beam is narrower than what the one or more transmission beams were before the capacity increase. The capacity of the transceiver apparatus may also be decreased by reducing the number of transmission amplifiers and widening the shape of at least one of the transmission beams.

At least one new transmission amplifier may be added in the transceiver apparatus, said new transmission amplifier providing a different transmission power than at least one of the transmissions power amplifiers used in the transceiver before the change. The power of the already existing amplifier elements may also be changed.

The transceiver apparatus control software may be reconfigured during the capacity change. The reconfiguration may be accomplished automatically after the number of branches is changed.

According to another aspect of the present invention there is provided transceiver apparatus, comprising: receiving means; transmitting means comprising at least one transmission branch provided with at least one transmission amplifier, the at least one transmission branch being enabled to generate at least one transmission beam for wireless transmission within the coverage area of the at least one beam; and means for digitally forming at least one of the transmission beams, wherein the capacity of the transceiver apparatus is arranged to be changeable by changing the number of the transmission branches and by modifying at least one of the transmission beams so that the coverage area thereof is adapted to the new number of transmission branches.

The transceiver apparatus may comprise mounting means that are adapted to enable insertion of an additional transmission amplifier. At least one of the transmission amplifiers may be mounted in a disengageable manner.

The transceiver apparatus may be used in a base station of a communication system. The communication system may be a third generation cellular communication system.

The embodiments of the invention may provide a possibility for a substantially large initial coverage while the initial investment to the base station (or several base stations) is kept in a relatively low level by providing only a relatively low number of transmission branches at the first instance. The embodiments may also enable flexible increase/decrease of the capacity when any capacity upgrade is deemed necessary. The embodiments may also enable flexible use of base station elements. The embodiment may allow increase in spectral efficiency by means of adding more transmission branches.

### BRIEF DESCRIPTION OF DRAWINGS

For better understanding of the present invention, reference will now be made by way of example to the accompanying drawings in which:

FIG. 1 shows a transceiver arrangement;

FIG. 2 is a schematic top view of a sector of a base transceiver station;

FIG. 3 shows a transmitter port arrangement constructed in accordance with an embodiment of the present invention;

FIGS. 4A to 4C illustrate a possible capacity increase sequence in a transceiver; and

FIG. 5 is a flowchart illustrating the operation of one embodiment of the present invention.

### DESCRIPTION OF PREFERRED EMBODIMENTS OF THE INVENTION

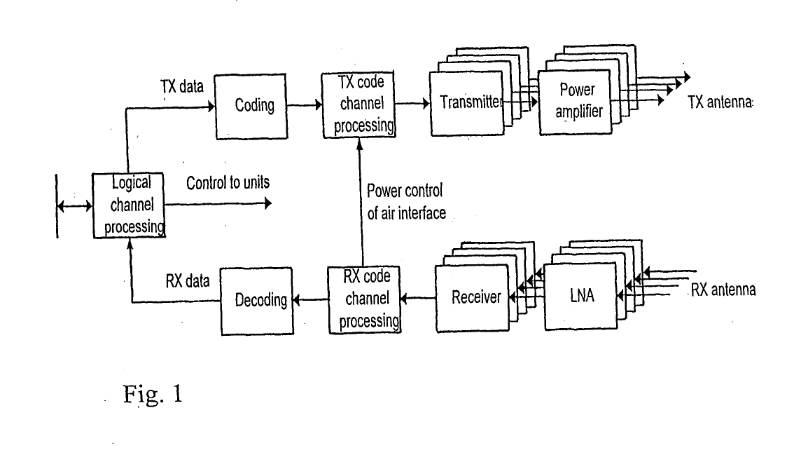

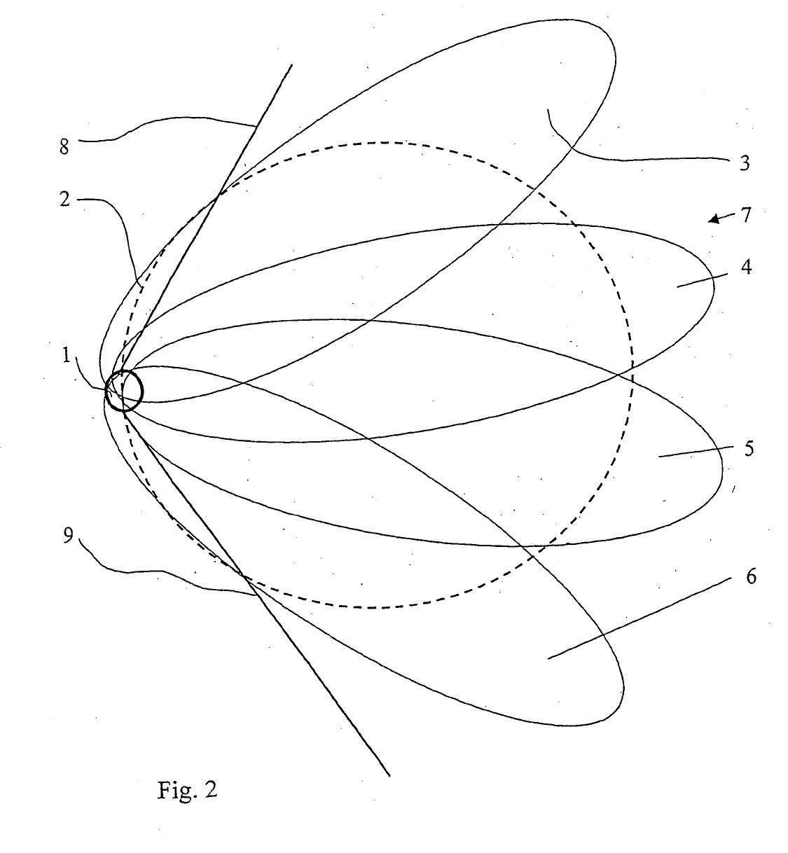

Reference is first made to FIG. 2 which shows an embodiment of the present invention. More particularly, FIG. 2 is a top view of a sector base transceiver station 1 and coverage area provided by one sector 7 thereof. The skilled person knows that a base station may be divided into a plurality of sectors, such as to three or four sectors. Each of the sectors is typically provided with transceiver apparatus, such as the transceiver shown in FIG. 1, so that the base station 1 may provide an omnidirectional coverage. It should be appreciated that a base station does not necessarily need to be a sector base station and that a base station does not necessarily provide an omnidirectional coverage, but may be a directional base station. In addition, although this specification refers to transceivers, it should be understood that the transmission and reception elements may be separated from each other, and that the term transceiver refers to a logical entity providing the transmission and reception functions. The sector 7 of the base station 1 is shown to cover area between lines 8 and 9. For clarity reasons FIG. 2 does not show any of the receiving branches (for the RX branches, see FIG. 1). However, the sector 7 may be covered, for example, by eight receiving branches.

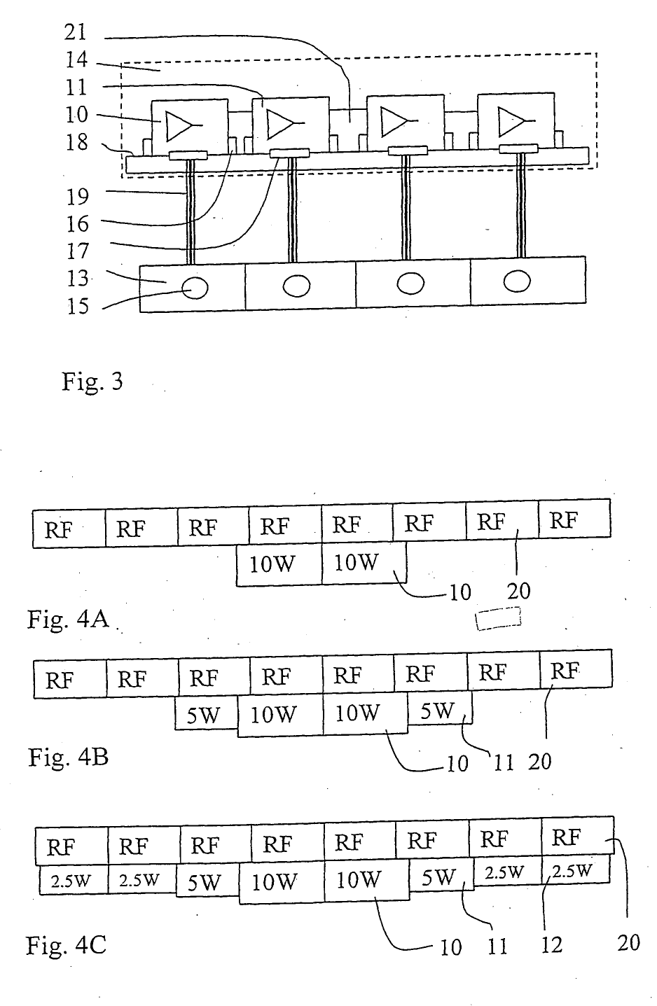

The base station apparatus 1 is shown to produce an initial transmission beam 2. The coverage area of the initial transmission beam 2 is illustrated by the dashed line. When the base station 1 was initially implemented to provide transmission coverage for the area 7 between the lines 8 and 9, is was decided that a sufficient capacity is obtainable by a single transmission beam. The initial number of receiver branches is thus substantially larger (e.g. the above mentioned eight) than the number of transmission branches (one). The beam 2 is produced by means of a transmission branch (see FIG. 3). As shown by FIG. 1, each transmission (TX) branch is typically provided with a power amplifier.

FIG. 2 shows also a situation after the capacity of the sector 6 of the base station 1 has been upgraded. After the upgrade the transceiver apparatus of the base station 1 is shown to provide four transmission beams 3 to 6. This has been obtained by increasing the number of transmission branches to four. In the preferred embodiment this means increasing the number of antenna elements and associated power amplifiers and baseband capacity. Appropriate baseband capacity increase upgrade procedures are known by the skilled person, and are supported e.g. by the WCDMA base stations and IS-95 base stations, and will thus not be explained in more detail.

During the upgrading the number of transmission branches may be increased e.g. up to the number of receiver branches, such as up to eight transmission branches if eight receiver branches are employed. At present it is believed that it may be preferable to limit the number of the transmission branches so that the number of transmission branches will not be higher than the number of receiving branches. It should, however, be appreciated that the number of receiver branches does not necessarily limit the number of the transmission branches.

When the number of transmission branches is increased a corresponding number of additional power amplifiers is typically required. This is illustrated in FIG. 3, wherein the initial transmission branch was provided by means of a transmitter or antenna element 15 and associated power amplifier 10. The antenna element 15 may be mounted on an antenna element mounting rack or similar antenna element mounting means 13. The rack 13 may be mounted on top of a base station antenna pole or other mounting structure (not shown). The power amplifier 10 may be mounted in a base station equipment housing or similar control equipment cabin 14 (illustrated by the dashed line) comprising a mounting rack or element 18 for receiving the amplifier 10 and other circuitry 21 that may be required for the generation of the transmission signal. The control instrument housing 14 is preferably located such that it is readily accessible for maintenance and upgrade operations, as will be explained later. In practice this may mean that while the antenna elements 15 are located as high as possible, the control cabinet 14 is located on the ground or elsewhere where an easy access is enabled. The element 15 and the power amplifier 10 and other possible circuitry are connected by means of cabling 19 therebetween.

The mounting rack element 13 is shown to be provided with three added transmitting branches and associated amplifiers 11, the total number of transmission branches being four. Each of the transmission branches is preferably capable of serving the entire coverage area of the transceiver. The element 13 is provided also with attachment means 17 for mounting the power amplifiers 10 and 11 on the element 13. The attachment means are preferably releasable thereby enabling quick assembly and/or replacement of the amplifiers 10 and 11. FIG. 3 shows also connectors 16 for coupling the power amplifiers and the antenna elements to each other via appropriate cabling means 19. The skilled person is familiar with various appropriate means for attaching and connecting the amplifiers in association with the antenna elements (such as coaxial cables for the connection), and therefore they will not be described in more detail herein.

The sole addition of new transmission branches (and thus transmission power) does not increase the capacity that is restricted by interference. Therefore, and as is shown by FIG. 2, the new transmission beams 3 to 6 are shaped to have a narrower coverage that what the original beam 2 had. The new beam 3 is actually the initial beam 2 that has been reshaped (narrowed) by means of beam modification to cover a smaller area, as will be explained below.

The inventors have found that digital beamforming (DBF) can be employed for the shaping the beams 2 to 6. In the digital beamforming the transmission beam is formed at the baseband by means of appropriate phasing of the signal in each transmission branch. The phasing may be accomplished by multiplying the complex digital samples in each transmission branch with a complex weight factor. The set of weight factors (one factor for each branch) is called the weight vector. A different weight vector may be used for transmission and reception. In each capacity upgrade step the transmission weight vectors are changed in such a way that a larger number of narrower beams are created employing the higher number of available transmission branches, while the reception weight vectors can be kept unchanged. On contrary to that, in an analogue fixed beam implementation the beam is formed by an analogue Butler matrix permanently connected to an antenna array. Thus when the same array is used for the transmission and reception, the number of beams will also be the same (e.g. eight reception and transmissions beams).

The base station arrangement is preferably constructed such that the additional new power amplifiers 11 can be easily mounted therein, e.g. by means of the coupling and attachment means 16, 17 of FIG. 3. The base station may be provided with an instrument or accessory housing that is located e.g. on the ground close to the base station mast or on the mast close to the antenna elements. The housing may be provided with appropriate racks or similar means adapted to receive the additional amplifiers, should a need for capacity increase arise.

It may also be desired to be able to remove one or more of the power amplifiers and thus reduce the number of the transmission branches, e.g. in situations where the capacity increase has been required only for a limited period of time. An example of such is provision of capacity for an event with great expected attendance. It may also be realised after the implementation of the network that only a portion of the initial base station capacity is actually used. The removal of the unnecessary power amplifiers and use of the amplifiers in another base station may thus provide the operator of the network with a possibility to optimise the investment and to use the bought resources in a flexible manner.

The control software of the base station 1 is preferably constructed such that it adapts to any changes in the number of transmission branches. The adaptation may be automatic. In this case the controller recognises that a new transmission element (such as a new power amplifier and/or antenna) has been installed or that a transmission element has been removed. The technician installing/removing the element may also manually update the parameters in the software that associate with the number of the transmission branches.

According to a further embodiment the additional power amplifiers can have lower power than the first or initial power amplifiers. This is due to the fact that a larger transmission array typically has a higher gain and therefore the power requirements of individual power amplifiers can be reduced. The first amplifier may provide communication channels such as common channels and may thus need more power than the additional power amplifiers. Also, since extra power does not give much capacity gain in interference limited systems, such as the WCDMA, the additional power amplifiers may be of a smaller nominal size. It should be appreciated that it is also possible to add a power amplifier having a higher nominal power that what the existing amplifiers had.

For example, if it is assumed that a 20W linear power amplifier (LPA) is required at the initial transceiver arrangement, three 5W LPAs may be added later. According to another example shown in FIGS. 4A to 4C, the initial construction comprises eight reception elements 20 providing the receiving branches and two transmission elements 10. The original implementation comprises two 10W power amplifiers 10. In the first upgrade two new 5W power amplifiers 11 are added. If it is later found that a second upgrade is required, it is possible to add four 2.5W power amplifiers 12. According to a possibility the original 10W amplifiers are also replaced by 5W amplifiers in the first upgrade. In the second upgrade all amplifiers are replaced so that the transmission function is provided by eight 2.5W amplifiers.

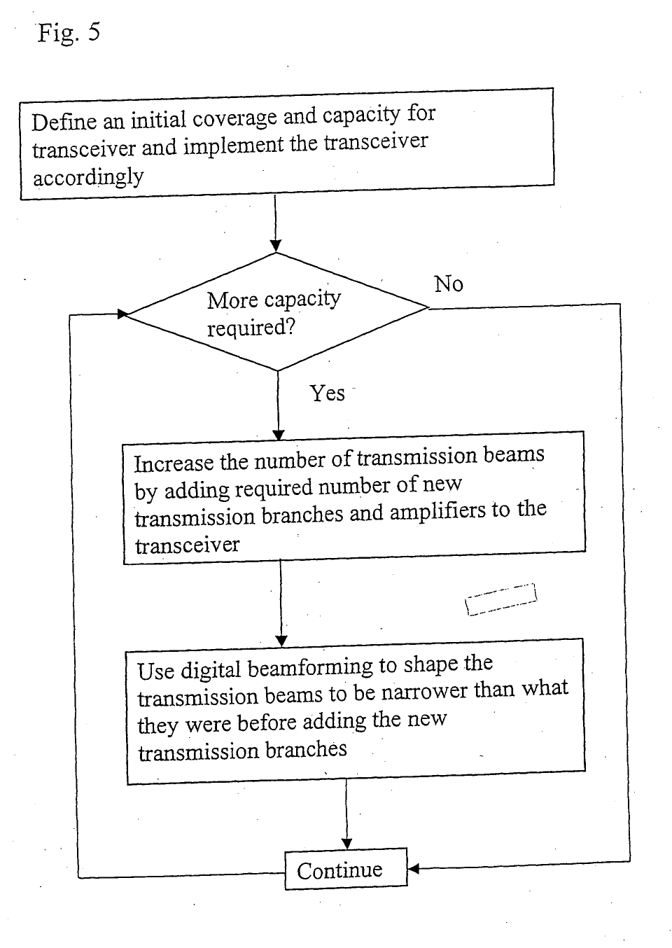

The operation of the above discussed embodiments is illustrated by the flowchart of FIG. 5.

In accordance with an embodiment, the capacity upgrade employs digital beam steering (DBS). The digital beam steering refers to a digital beamforming method in which the transmission beams are formed and directed to a direction in which the user(s) is(are) located. The digital beam steering may be adaptive, that is the system tracks the users and adaptively directs the beams towards the located users. The tracking may be based e.g. on detected transmission from a mobile station. When the digital beam steering is employed for modifying the shape of the coverage area of the beam, the digital beam steering may modify the transmission beam such that it becomes narrower or wider whenever the number of transmission branches is increased/decreased, thereby increasing/decreasing the capacity.

One advantage of the embodiments is that common channels can be arranged through single antenna elements while an analogue approach requires a separate antenna (though integrated in the fixed beam antenna panel) and feeder for common communication channels. In the embodiments the capacity of the base transceiver station can be increased in accordance with the operator's actual capacity needs as the number of users/traffic increases by “plugging” in more power amplifiers when required. A software configuration update may be accomplished, essentially replacing the transmission weight vectors with new values that provide a higher number of narrower beams or alternatively a narrower beam that may be steered based on the location of the user or locations of several users. Therefore at initial launch of the network the operator may employ cheaper base stations because fewer power amplifiers are needed. The embodiments may enable flexible management of the transceiver resources since the control of the capacity and coverage resources can be separated from each other.

It should be appreciated that whilst embodiments of the present invention have been described in relation to base stations, embodiments of the present invention are applicable to any other suitable type of transceiver equipment. This invention is also applicable to any type of radio access techniques including code division multiple access, frequency division multiple access or time division multiple access as well as any hybrids thereof. It should also be appreciated that is some system, such as in the WCDMA radio access network (RAN) the mobile user is served by a transceiver element referred to as Node B.

It is also noted herein that while the above describes exemplifying embodiments of the invention, there are several variations and modifications which may be made to the disclosed solution without departing from the scope of the present invention as defined in the appended claims.

1. A method in transceiver apparatus, the transceiver transmitting within the coverage area of one or more transmission beams provided by means of at least one transmission branch, the method comprising:
changing the number of transmission branches of the transceiver; and
modifying the shape of at least one transmission beam by means of digital beamforming.

2. A method as claimed in claim 1, wherein the changed number of transmission branches produces a correspondingly changed number of transmission beams.

3. A method as claimed in claim 1 or 2, wherein the width of said at least one transmission beam is changed by means of the digital beamforming.

4. A method as claimed in claim 3, wherein the angular width of said at least one beam is changed.

5. A method as claimed in claim 3 or 4, wherein the digital beam forming provides adaptive steering of the transmission beams for serving a predefined mobile user or a predefined group of mobile users.

6. A method as claimed in any of claims 1 to 4, wherein the digital beam forming provides a set of fixed transmission beams serving mobile users within the coverage area thereof.

7. A method as claimed in any preceding claim, wherein the receiver function of the transceiver is provided with receiver branches, the initial number of the receiver branches being greater than the initial number of the transmission branches.

8. A method as claimed in claim 7, wherein the number of transmission branches is increased to equal the number of receiver branches.

9. A method as claimed in any preceding claim, wherein said at least one transmission beam is shaped to be narrower than a transmission beam that was provided by the transceiver before the change.

10. A method as claimed in any preceding claim, wherein the capacity of the transceiver apparatus is increased by increasing the number of transmission amplifiers for increasing the number of transmission branches and shaping at least one of the transmission beams produced by the increased number of the transmission branches so that at least one transmission beam is narrower than what the one or more transmission beams were before the capacity increase.

11. A method as claimed in any preceding claim, wherein the capacity of the transceiver apparatus is decreased by reducing the number of transmission amplifiers and widening the shape of at least one of the transmission beams.

12. A method as claimed in any of the preceding claims, wherein at least one new transmission amplifier is added in the transceiver apparatus, said new transmission amplifier providing a different transmission power than at least one transmissions amplifier used in the transceiver before the change.

13. A method as claimed in claim 12, wherein new amplifier has a lower transmission power than the at least one transmission amplifier used before the change.

14. A method as claimed in claim 13, wherein the power of the new amplifier is about half of the power of said amplifier already in use.

15. A method as claimed in claim 12, wherein new amplifier has a higher transmission power than the at least one transmission amplifier used before the change.

16. A method as claimed in any preceding claim, wherein the power of the already existing amplifier elements is changed.

17. A method as claimed in any preceding claim, wherein said at least one beam is shaped by means of phasing the baseband signals of the transmission branches.

18. A method as claimed in claim 17, wherein the phasing comprises multiplying complex digital samples in each transmission branch with a complex weight factor.

19. A method as claimed in claim 18, wherein different weight vectors are used for transmission and reception.

20. A method as claimed in claim 19, wherein the transmission weight vectors are changed such that a larger number of narrower beams is created by employing a higher number of available transmission branches while the reception weight vectors are kept unchanged.

21. A method as claimed in any preceding claim, wherein the transceiver is contained in a base station of a wireless communication system.

22. A method as claimed in claim 21, wherein the wireless communication system is a third generation cellular communication system.

23. A method as claimed in any preceding claim, comprising reconfiguration of the transceiver apparatus control software.

24. A method as claimed in claim 23, wherein the reconfiguration is accomplished automatically after the number of amplifiers is changed.

25. A method as claimed in claim 23 or 24, wherein the reconfiguration comprises replacing transmission weight vectors with new values that enable provision of a different number of transmission beams.

26. A method as claimed in any preceding claim, comprising changing the baseband capacity of the transceiver apparatus.

27. Transceiver apparatus, comprising:
receiving means;
transmitting means comprising at least one transmission branch provided with at least one transmission amplifier, the at least one transmission branch being enabled to generate at least one transmission beam for wireless transmission within the coverage area of the at least one beam; and
means for digitally forming at least one of the transmission beams, wherein the capacity of the transceiver apparatus is arranged to be changeable by changing the number of the transmission branches and by modifying at least one of the transmission beams so that the coverage area thereof is adapted to the new number of transmission branches.

28. Transceiver apparatus as claimed in claim 27, comprising mounting means that are adapted to enable insertion of an additional transmission amplifier.

29. Transceiver apparatus as claimed in claim 27 or 28, wherein at least one of the transmission amplifiers is mounted in a disengageable manner in association with the transceiver apparatus.

30. Transceiver apparatus as claimed in any of claims 27 to 29, wherein the width of at least one transmission beam is adapted to be changed by the means for digital beamforming.

31. Transceiver apparatus as claimed in any of claims 27 to 30, wherein the at least one transmission beam is adaptively modified.

32. Transceiver apparatus as claimed in any of claims 27 to 31, the arrangement being such that the initial number of receiver branches is greater than the initial number of the transmission branches, and after the capacity change the number of transmission branches equals the number of receiver branches.

33. Transceiver apparatus as claimed in claim 28 or any claim when appended to claim 28, wherein the additional transmission amplifier is adapted to provide a different transmission power than at least one of the transmission power amplifiers used for the transceiver apparatus before the change.

34. Transceiver apparatus as claimed in any of claims 27 to 33, wherein the means for digital beamforming are arranged to shape said at least one beam by means of phasing the baseband signals of the transmission branches.

35. Transceiver apparatus as claimed in any of claims 27 to 34, wherein the means for digital beamforming is controlled by a control software, said control software being reconfigurable to adapt to the change of transmission amplifiers.

36. Transceiver apparatus as claimed in any of claims 27 to 35, comprising means for changing the baseband capacity of the transceiver apparatus.

37. A base station for a communication system, comprising a transceiver apparatus as claimed in any of claims 27 to 36.

38. A base station as claimed in claim 37, wherein the communication system is a third generation cellular communication system.
